(19) United States
(12) Patent Application Publication
(10) Pub. No.: US 2007/0187930 A1
(43) Pub. Date: Aug. 16, 2007

(54) AUTOMOTIVE STRUCTURES WITH HIDDEN AIRBAG DOOR AND INTEGRATED AIRBAG CHUTE

(76) Inventors: Ravi Kiran Chitteti, Bangalore (IN); Takaaki Nemoto, Mishima (JP); Chang-Soo Ryu, (US); Adam K. Trappe, Casco, MI (US); Ted J. Wieczorek, Rochester Hills, MI (US)

Correspondence Address: GEAM - 08CT;IP LEGAL, ONE PLASTICS AVENUE, PITTSFIELD, MA, 01201-3697, US

(21) Appl. No.: 11/563,699

(22) Filed: Nov. 28, 2006

Related U.S. Application Data
(60) Provisional application No. 60/774,068, filed on Feb. 16, 2006.

(51) Int. Cl. B60R 21/205; B60R 21/215

(52) U.S. Cl. 280/728.2; 280/728.3; 280/732

(57) ABSTRACT

A motor vehicle structure that includes a hidden airbag door and an integrated airbag chute. The structure may be selected from instrument panel assemblies, seat shields, airbag covers, pillar garnishes, side curtain shields, door trim, knee bolsters, or a combination of one or more of the foregoing structures. The structure is designed to include a retainer having a first surface and a second surface, a deployment chute, and a door portion defined by a tear seam notch in at least one of the first surface and the second surface of the retainer. The deployment chute is attached to and integrated with the retainer. Additionally, the deployment chute and the retainer are constructed and arranged from the same material. The motor vehicle structure may be made by integrally forming the deployment chute with the retainer and defining a door portion using a tear seam notch in at least one of the first surface and the second surface of the retainer. The motor vehicle structures of the present invention require fewer process steps to make and may have increased structural strength as compared to prior art structures.

### CROSS REFERENCE TO RELATED APPLICATIONS

This application claims priority to U.S. Provisional Application No. 60/774,068, which was filed Feb. 16, 2006.

### FIELD OF INVENTION

The present invention relates to structures used in motor vehicles and, in particular, to airbag systems contained within one or more motor vehicle structures.

### BACKGROUND OF INVENTION

Airbags and their use as a safety mechanism in motor vehicles, such as automobiles and trucks, have become widespread and mainstream. In many motor vehicles, passenger airbags are currently designed to be integrated within the instrument panel assembly. In addition, airbags are being located in increased areas to add additional protection to a driver and any passengers in the vehicle.

One primary location of airbags is in instrument panel assemblies. Some prior art instrument panel assemblies may include a beam structure and/or at least one decorative instrument panel attached to the beam structure. Some of the decorative panels act as knee bolsters to protect the knees of vehicle occupants in the event of an impact. An instrument panel assembly may be mounted inside the passenger compartment of an automobile with the beam structure attached to the automobile body, or vehicle structure. The beam structures may be fabricated from metal or plastic.

Still other prior art assemblies include vehicle systems that are housed within the instrument pane assembly, such as for example, the heating, ventilating, and air conditioning (HVAC) system, and the airbag system(s). To permit deployment of the airbag, the instrument panel includes an airbag opening covered by an airbag door. The placement of a door in the middle of a smooth surfaced instrument panel may be considered aesthetically unacceptable because the door destroys the clean aesthetic lines of an instrument panel. The deployment of the airbag forces the door open to permit the airbag to exit through the opening in the instrument panel.

Many instrument panel assemblies include an instrument panel retainer, an airbag, and an airbag chute that acts as a collar sitting in between the retainer and the airbag. For the airbag to deploy a door may be provided in the instrument panel that provides an area for the deployment of the airbag. This door may be hidden within the panel, or be a separate, visible piece. The door may operate using the deploying airbag. When the airbag is activated, the airbag may then expand towards the doors. The airbag may then contact the inner side of the door such that the airbag supplies a force to open the door. The door is opened by the airbag pressing on the inner side, which applies enough force to separate the material of the door. For the door to open in a desired manner seams or fracture points may be provided on the door.

In these prior art embodiments a chute is provided for guiding the airbag during deployment. This chute may be a molded plastic part that the passenger airbag mounts to on the top surface of the instrument panel. The airbag doors may also include multiple separate steel pieces that are used to provide strength to the doors. In some embodiments, the chute and door can be molded as a unit. The steel inserts could then be inserted and molded into the unit.

Nevertheless, the use of a chute and/or chute/door units results in an additional piece and/or process step that must be used to form the airbag assembly. For example, the chute may be attached to the retainer. In prior art embodiments the chute may be, in some embodiments, attached to the retainer using vibration welding and/or mechanical welding. In alternative embodiments, other mechanical attachment mechanisms are used, such as mechanical fasteners. Accordingly, this additional welding step increases the process time and/or costs associated with manufacturing instrument panel airbag assemblies. As such, it would be beneficial to provide a motor vehicle structure, such as an instrument panel assembly, that includes an airbag assembly that is easier to construct and/or relies on fewer pieces that could fail prior to operation.

### SUMMARY OF THE INVENTION

The present invention provides an airbag system that utilizes the same material for forming two or more components of an airbag system included in a structure capable of deploying an airbag. The airbag assembly can be contained within a variety of motor vehicle assemblies. In one embodiment, the airbag system is contained in an instrument panel that includes a retainer having a first surface and a second surface, a deployment chute, and a door portion defined by a tear seam notch in at least one of the first surface and the second surface of the retainer. The deployment chute is attached to and integrated with the retainer. Additionally, the deployment chute and the retainer are constructed and arranged from the same material. The instrument panel assembly may be made by integrally forming the deployment chute with the retainer and defining a door portion using a tear seam notch in at least one of the first surface and the second surface of the retainer. Other structures that may include the concepts of the present invention include seat shields, airbag covers, pillar garnishes, side curtain shields, door trim, knee bolsters, or a combination of one or more of the foregoing structure. The structures of the present invention requires fewer process steps to make and may have increased structural strength as compared to prior art systems.

In one aspect, a motor vehicle structure is provided. The motor vehicle structure includes a retainer having a first surface and a second surface, a deployment chute, and a door portion defined by a tear seam notch in at least one of the first surface and the second surface of the retainer. The deployment chute and the retainer are constructed and arranged from the same material. Additionally, the deployment chute is attached to and integrated with the retainer to form a single piece component. In another aspect, a two-shot molding process could be used which would result in the deployment chute and the retainer being constructed in one process but with differing materials. The motor vehicle structure may be selected from instrument panel assemblies, seat shields, airbag covers, pillar garnishes, side curtain shields, door trim, knee bolsters, or a combination of one or more of the foregoing structures.

In another aspect, a method of making a motor vehicle structure is provided. The method includes the steps of integrally forming a deployment chute to a retainer having a first surface and a second surface; and defining a door portion using a tear seam notch in at least one of the first surface and the second surface of the retainer. The deployment chute and the retainer are constructed from the same material. The deployment chute and retainer may be constructed in a single-step process. The motor vehicle structure may be selected from instrument panel assemblies, seat shields, airbag covers, pillar garnishes, side curtain shields, door trim, knee bolsters, or a combination of one or more of the foregoing structures.

### BRIEF DESCRIPTION OF THE DRAWINGS

FIG. 1 is a perspective view of a separate airbag chute according to the prior art.

FIG. 2 is a perspective view of an integrated airbag and airbag chute according to one embodiment of the present invention.

FIG. 3 is a cross-section view of the integrated airbag and airbag chute of FIG. 2 along line A-A.

FIG. 4 is a cross-section view of the integrated airbag and airbag chute of FIG. 2 along line B-B.

FIG. 5 is a perspective view of an integrated airbag and airbag chute according to an alternative embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides an improved motor vehicle structure for containing an airbag and methods of making these structures. The improved structure results from forming a retainer substrate and a deployment chute from the same material such that the retainer substrate and the deployment chute are integrally connected to one another, thereby obviating the need for any welds or mechanical fastening means to attach the deployment chute to the retainer. The improved structure could also result from forming a retainer substrate and a deployment chute from differing materials in a two shot process such that the retainer substrate and the deployment chute are integrally connected to one another, thereby obviating the need for any welds or mechanical fastening means to attach the deployment chute and retainer. As such, the motor vehicle structures are simpler to make and include fewer mechanical pieces that could be subject to breaking over time, adversely affecting the performance of the airbag if needed.

The concepts of the present invention may be utilized in any motor vehicle structure capable of containing an airbag system including a substrate and a deployment chute. As used herein, the term “chute” or “deployment chute” refers to any mating geometry or component that connects an airbag main structure (e.g. an instrument panel retainer, knee bolster, topper, etc.) to the airbag. In some embodiments, the chute may serve as a guide for the airbag, while in other embodiments the chute may serve as an attachment method. Other terms that may be used in defining the chute may include “guide” or “collar” or any related structure capable of performing this function.

By eliminating any welds or mechanical fastening means to attach the deployment chute to the retainer, the methods for making the improved instrument panel assemblies require less steps since the deployment chute may be formed integrally with the retainer rather than requiring a separate welding or fastening step. Also, by integrally connecting the deployment chute to the retainer assembly, there are no welds or mechanical fastening means that can break or come apart, thereby providing a motor vehicle structure having an airbag system that may have increased strength and/or durability as compared to prior art motor vehicle structures that include an airbag system.

The foregoing and other features of the present invention will be more readily apparent from the following detailed description and drawings of the illustrative embodiments of the invention wherein like reference numbers refer to similar elements.

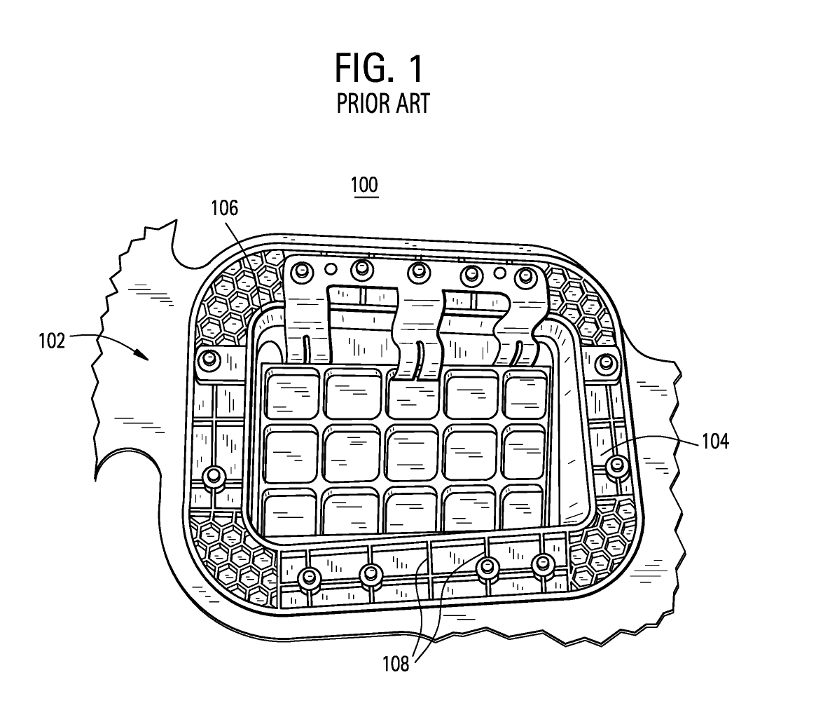

Referring to the drawings, FIG. 1 is a perspective view of a prior art instrument panel assembly 100. The instrument panel assembly 100 includes an exterior surface (not shown) that faces into the interior of the vehicle, and an interior surface that faces away from the interior of the vehicle. The assembly 100 includes a retainer substrate 102. A chute 104 is mounted to the interior surface of the retainer substrate 102. The chute 104 includes a front surface attached to the interior surface and an opening 106 extending therethrough. The chute 104 may be mounted to the retainer substrate 102 such that the opening 106 is aligned with a panel door of the assembly 100. The front surface of the chute 104 further includes a plurality of welding ribs 108 formed on the front surface. The welding ribs 108 are adapted to allow the chute 104 to be vibration welded to the retainer substrate 102 of the assembly 100. In certain variations, the welding ribs 108 extend parallel to each other around the opening 106 within the chute 104.

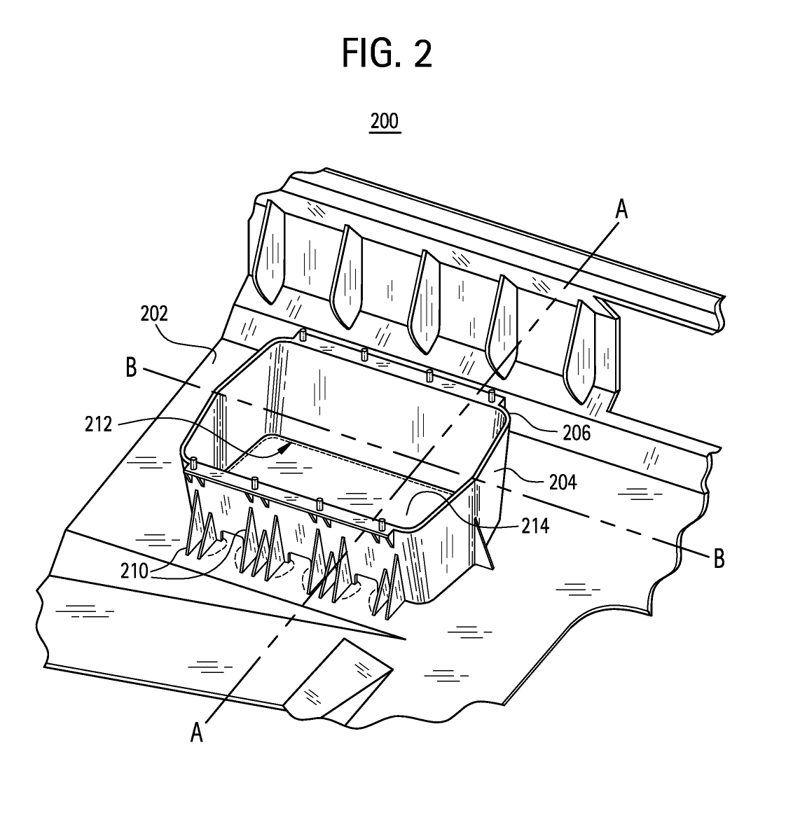

In the present invention, however, which is shown in greater detail in FIG. 2, the assembly 200 includes a retainer substrate 202 and chute 204 that are integrally joined to one another using the process by which the retainer substrate 202 and chute 204 are initially formed. Accordingly, when the chute 204 and retainer substrate 202 are formed from a thermoplastic material, for example, the chute 204 and retainer substrate 202 can be formed such that they are a single piece. This may be accomplished using any known molding technique, such as injection molding. As a result, the chute 204 is already attached to the retainer substrate 202 and no subsequent step of vibration welding is needed to attach the chute 204 to the substrate 202 as is required in the prior art embodiment shown in FIG. 1. In addition, depending on the materials used to form the chute 204 and retainer substrate 202, the resulting structures of the present invention may be stronger since there are no weld points that may break.

As with the chute in FIG. 1, chute 204 includes an opening extending 206 there through and a plurality of support ribs, to be used if necessary 210, which may also be formed during the process by which the chute 204 and retainer substrate 202 are formed.

In additional embodiments of the present invention, and as seen in FIGS. 2-4, the instrument panel assemblies may include one or more pre-weakened outlines 212 formed therein which define a panel door 214 within the retainer substrate 202. The pre-weakened outline 212 permits the retainer substrate 202 to maintain structural integrity and appearance while providing a weakened outline that will break away under the pressure of the deploying airbag. When the air bag is deployed, the force is sufficient to break the panel door 214 away from the remaining portion of the retainer substrate 202 along the pre-weakened outline 212. The pre-weakened outline 212 may be formed by any method capable of forming a pre-weakened outline in a substrate. In one embodiment, angled laser scoring the interior surface of the retainer substrate 202 forms the pre-weakened outline 212.

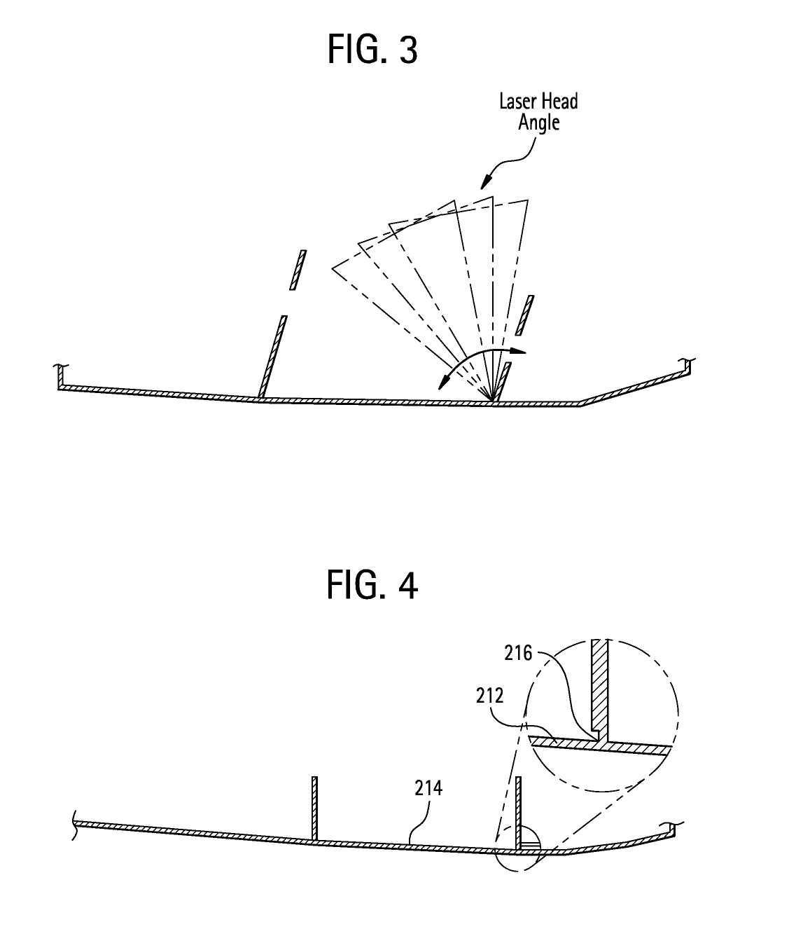

As seen in FIG. 3, in one embodiment, angled laser scoring may be used around the opening 206 of the chute 204 to form the hinges 216 of the door 214. And, as may be seen in FIG. 4, angled scoring of the main seam itself may be used to prevent door “push-in” from non-airbag incidental impacts like consumer hitting/abnormal abuse, head impact testing, etc.

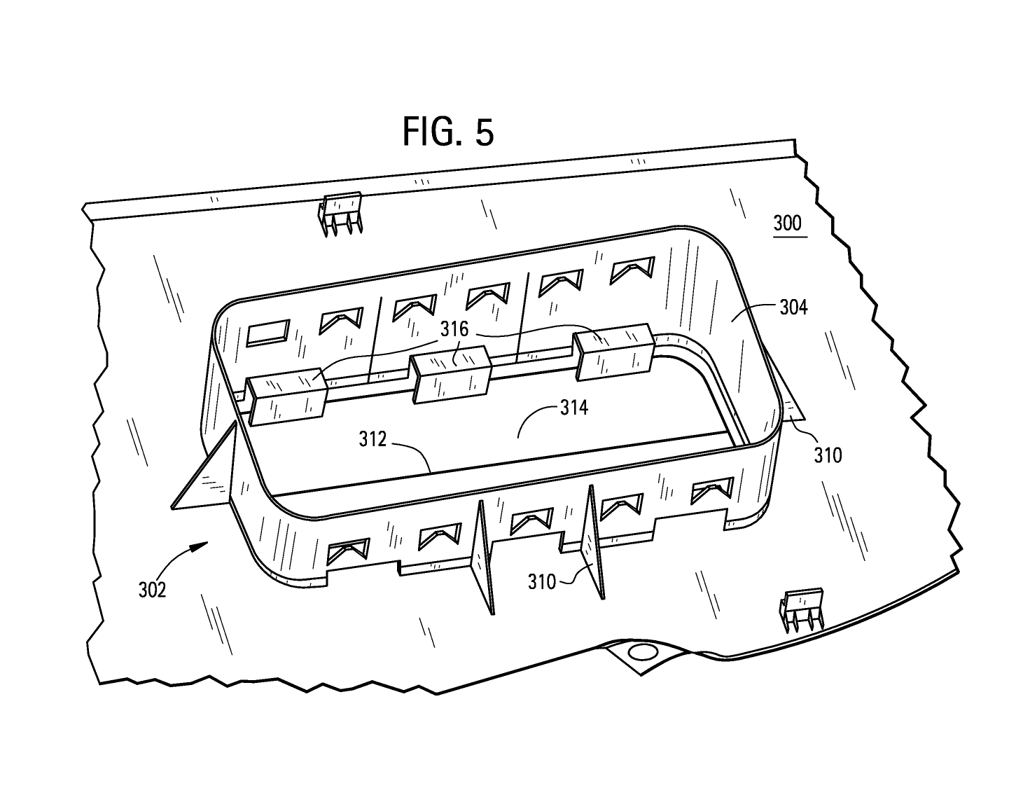

FIG. 5 provides an alternative embodiment to laser scoring of the hinges. Rather, in this embodiment, the hinges 316 of the door 314 are formed during the molding process. As such, the assembly 300 includes a chute 304, a retainer substrate 302, and one or more hinges 316 that are integrally formed with one another. The assembly 300 still includes a panel door 314 that may be formed using laser scoring to form a pre-weakened outline 312. This embodiment also shows the use of one or more support ribs 310.

In alternative embodiments, the chute is designed to have zero draft and/or bell shaped openings of the chute such that the retainer has no-sinks. Nevertheless, the resulting instrument panel would still have good ejection characteristics when ejected from the mold. Alternatively, the deployment chute may be designed such that it has a slightly oval chute shape, so as to form a deployment chute potentially having two lifters (or slides) instead of four. Other shapes of openings include, but are not limited to, a rectangular shaped opening and/or a trapezoidal opening.

In one embodiment of the present invention, the chute and retainer substrate are constructed from a material that is capable of being formed from one piece. Examples of such materials include, but are not limited to, metals and plastics. In select embodiments of the present invention, the chute and retainer are constructed from a plastic material, such as a thermoplastic material. In beneficial embodiments, the plastic material is a thermoplastic material that is flexible at temperatures of about 200° C. to about −60° C. Examples of thermoplastic materials that may be used in the present invention include, but are not limited to, acrylonitrile-butadiene-styrene (ABS), polycarbonate (LEXAN® and LEXAN® EXL resins commercially available from General Electric Company), polycarbonate/ABS blend (CYCOLOY® resins from General Electric Company), a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide (NORYL GTX® resins from General Electric Company), blends of polycarbonate/PET/PBT, polybutylene terephthalate and impact modifier (XENOY® resins commercially available from General Electric Company), polyamides, phenylene sulfide resins, polyvinyl chloride PVC, high impact polystyrene (HIPS), low/high density polyethylene, polypropylene and thermoplastic olefins (TPO), polyethylene and fiber composites, and polypropylene and fiber composites such as AZDEL Superlite™ sheets commercially available from AZDEL, Inc.

In alternative embodiments, the chute and retainer are constructed from a metal. Examples of metals that may be used in the present invention include, but are not limited to, steel, aluminum, iron, alloys of one or more of these, or combinations thereof.

The integrated chute and retainer may be formed using any method capable of forming a one-piece integrated chute and retainer assembly. The method used may be chosen using one or more factors including, but not limited to, the materials used to form the integrated chute and retainer assembly, the type of instrument panel assembly in which the integrated chute and retainer assembly is used, and/or the size of the integrated chute and retainer assembly to be formed. Examples of methods that may be used in the present invention include, but are not limited to, extrusion molding, blow molding, compression molding, injection molding, melt molding (such as co-extrusion molding, T-die extrusion, inflation extrusion, profile extrusion, extrusion coating and multi-layer injection molding) or a combination thereof.

In an alternative embodiment, the retainer and the deployment chute are constructed from different materials, such as the thermoplastic materials previously discussed, but are formed using a two-shot molding process such that the same molding process forms the integrated chute and retainer, thereby preserving the advantages over prior art airbag systems that require multiple steps for forming the retainer and attaching a deployment chute. The two-shot process first injects one thermoplastic material into the mold, and then injects the second thermoplastic around or over the first. The two-step manufacturing process is essentially achieved with the use of two injection units and a rotating platen. Half of the mold cavity is used for the first thermoplastic material while the other half contains the mold cavity for the second thermoplastic material.

The present invention may be used in any motor vehicle structure containing an airbag. As such, the concepts of the present invention may be used in any airbag assembly wherein a deployment chute is utilized, specifically a deployment chute used in conjunction with a retainer and wherein the retainer and deployment chute are capable of being constructed from a plastic material, such as a thermoplastic material. Examples of motor vehicle structures in which the concepts of the present invention may be used include, but are not limited to, instrument panel assemblies, seat shields, airbag covers, pillar garnishes, side curtain shields, door trim, knee bolsters, or a combination of one or more of the foregoing structures currently having a retainer that is vibration welded and/or mechanically welded to an airbag chute, an airbag collar, an airbag door, or a combination thereof. In those structures that include an airbag door, the door may be a metal door or a plastic door and/or may include hinges. The instrument panel retainer may, in some embodiments, include a pre-weakened tear seam.

In alternative embodiments, the motor vehicle structure includes an intermediate layer on the upper surface of the retainer substrate and/or a cover layer on the upper surface of any intermediate layer. In another embodiment, the motor vehicle structure does not have any additional layers on the upper surface of the retainer substrate. In still other another embodiments, the upper surface of the retainer substrate is painted.

If used, the intermediate layer may be formed from a resilient material, for example, a foam material. The resilient material may be used to provide added protection to vehicle occupants in impact events, to provide added aesthetics, and/or to provide added texture or quality to touch. The cover layer may be formed from any suitable decorative material, for example, a thermoplastic material, leather, fabric, and the like. With the application of an intermediate layer and/or a cover layer to the retainer substrate, the airbag door is not visible to a vehicle occupant. In an exemplary embodiment, any intermediate layer and/or cover layer does not contain tear seam scores or notches to aid the opening of airbag door. In other embodiments, at least one of any intermediate layer and/or cover layer also includes tear seam notches.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A motor vehicle structure for a motor vehicle passenger compartment comprising;
a retainer having a first surface and a second surface;
a deployment chute; and
a door portion defined by a tear seam notch in at least one of the first surface and the second surface of the retainer;
wherein the deployment chute is attached to and integrated with the retainer.

2. The motor vehicle structure of claim 1, wherein the deployment chute and the retainer are constructed and arranged from the same material and wherein the deployment chute and the retainer are constructed from a thermoplastic material.

3. The motor vehicle structure of claim 2, wherein the thermoplastic material is selected from acrylonitrile-butadiene-styrene (ABS), polycarbonate, polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide, blends of polycarbonate/PET/PBT, polybutylene terephthalate and impact modifier, polyamides, phenylene sulfide resins, polyvinyl chloride PVC, high impact polystyrene (HIPS), low/high density polyethylene, polypropylene and thermoplastic olefins (TPO), polyethylene and fiber composites, polypropylene and fiber composites, or a combination thereof.

4. The motor vehicle structure of claim 1, wherein the deployment chute and the retainer are constructed and arranged from different materials and wherein the deployment chute and the retainer are constructed from a thermoplastic material.

5. The motor vehicle structure of claim 4, wherein the thermoplastic material is selected from acrylonitrile-butadiene-styrene (ABS), polycarbonate, polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide, blends of polycarbonate/PET/PBT, polybutylene terephthalate and impact modifier, polyamides, phenylene sulfide resins, polyvinyl chloride PVC, high impact polystyrene (HIPS), low/high density polyethylene, polypropylene and thermoplastic olefins (TPO), polyethylene and fiber composites, polypropylene and fiber composites, or a combination thereof.

6. The motor vehicle structure of claim 1, wherein the deployment chute and the retainer are constructed from a metal.

7. The motor vehicle structure of claim 1, further comprising an airbag.

8. The motor vehicle structure of claim 1, wherein the tear stream notch comprises an angled stream notch.

9. The motor vehicle structure of claim 1, wherein the deployment chute includes an opening selected from an oval-shaped opening, a rectangular shaped opening, a trapezoidal opening, a zero draft opening, or a bell-shaped opening.

10. The motor vehicle structure of claim 1, wherein the motor vehicle structure is selected from an instrument panel assembly, a seat shield, an airbag cover, a pillar garnish, a side curtain shield, a door trim, a knee bolster, or a combination of one or more of the foregoing structures.

11. The motor vehicle structure of claim 1, wherein the motor vehicle structure comprises an instrument panel assembly.

12. A method of forming a motor vehicle structure comprising the steps of:
integrally forming a deployment chute to a retainer having a first surface and a second surface; and
defining a door portion using a tear seam notch in at least one of the first surface and the second surface of the retainer.

13. The method of claim 12, wherein the deployment chute and the retainer are formed in a single molding process using a same material for the deployment chute and the retainer and wherein the deployment chute and the retainer are constructed from a thermoplastic material.

14. The method of claim 13, wherein the thermoplastic material is selected from acrylonitrile-butadiene-styrene (ABS), polycarbonate, polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide, blends of polycarbonate/PET/PBT, polybutylene terephthalate and impact modifier, polyamides, phenylene sulfide resins, polyvinyl chloride PVC, high impact polystyrene (HIPS), low/high density polyethylene, polypropylene and thermoplastic olefins (TPO), polyethylene and fiber composites, polypropylene and fiber composites, or a combination thereof.

15. The method of claim 12, wherein the deployment chute and the retainer are formed in a single molding process from different materials for the deployment chute and the retainer and wherein the deployment chute and the retainer are constructed from a thermoplastic material.

16. The method of claim 15, wherein the thermoplastic material is selected from acrylonitrile-butadiene-styrene (ABS), polycarbonate, polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide, blends of polycarbonate/PET/PBT, polybutylene terephthalate and impact modifier, polyamides, phenylene sulfide resins, polyvinyl chloride PVC, high impact polystyrene (HIPS), low/high density polyethylene, polypropylene and thermoplastic olefins (TPO), polyethylene and fiber composites, polypropylene and fiber composites, or a combination thereof.

17. The method of claim 12, wherein the deployment chute and the retainer are integrally formed using a method selected from extrusion molding, blow molding, compression molding, injection molding, melt molding, or a combination thereof.

18. The method of claim 12, wherein angled laser scoring is used to define the door portion.

19. The method of claim 12, wherein the motor vehicle structure is selected from an instrument panel assembly, a seat shield, an airbag cover, a pillar garnish, a side curtain shield, a door trim, a knee bolster, or a combination of one or more of the foregoing structures.

20. The method of claim 12, wherein the motor vehicle structure comprises an instrument panel assembly.
